(19) United States
(12) Patent Application Publication
(10) Pub. No.: US 2021/0255719 A1
(43) Pub. Date: Aug. 19, 2021

(54) SYSTEMS AND METHODS TO CACHE DATA BASED ON HOVER ABOVE TOUCH-ENABLED DISPLAY

(71) Applicant: Lenovo (Singapore) Pte. Ltd., Singapore (SG)

(72) Inventors: Mengnan Wang, Chapel Hill, NC (US); John Weldon Nicholson, Cary, NC (US)

(21) Appl. No.: 16/792,203

(22) Filed: Feb. 15, 2020

(51) Int. Cl. G06F 3/044; G06F 3/0488; G06F 3/0482; G06F 9/445; G06F 12/0802

(52) U.S. Cl. CPC G06F 3/044; G06F 3/04883; G06F 12/0802; G06F 9/445; G06F 3/0482

(57) ABSTRACT

In one aspect, a device includes at least one processor, a touch-enabled display accessible to the at least one processor, and storage accessible to the at least one processor. The storage includes instructions executable by the at least one processor to detect a hover of a body part of a user or other physical object above the touch-enabled display, where the hover does not include the physical object physically touching the touch-enabled display. The instructions are also executable to identify a graphical object underneath the hover and to cache data associated with the graphical object prior to the graphical object being selected based on the physical object physically touching the touch-enabled display.

### FIELD

The present application relates to technically inventive, non-routine solutions that are necessarily rooted in computer technology and that produce concrete technical improvements.

### BACKGROUND

As recognized herein, there might sometimes be undue latency between when a graphical object presented on a display of a device is selected using touch-based input to the display and when the data associated with the object is actually presented on the display in response. As also recognized herein, this might be attributable to Internet communication delays, processor constraints, hard disk drive demands, etc. There are currently no adequate solutions to the foregoing computer-related, technological problem.

### SUMMARY

Accordingly, in one aspect a device includes at least one processor, a touch-enabled display accessible to the at least one processor, and storage accessible to the at least one processor. The storage includes instructions executable by the at least one processor to detect a hover of a body part of a user above the touch-enabled display, where the hover does not include the body part physically touching the touch-enabled display. The instructions are also executable to identify a graphical object underneath the hover and to cache data associated with the graphical object prior to the graphical object being selected based on the body part physically touching the touch-enabled display.

In some implementations, the device may include random-access memory (RAM) accessible to the at least one processor, and in these implementations the caching of the data may include loading the data into the RAM.

The hover may be detected based on input from at least one capacitive sensor in the touch-enabled display, such as at least one mutual capacitance sensor and/or at least one self-capacitance sensor. Additionally or alternatively, the device may include a camera accessible to the at least one processor, and the hover may be detected based on input from the camera.

The data may include a web page and/or a file. The file that is cached may be accessed from local storage on the device and/or accessed from cloud storage accessed over the Internet. Furthermore, the data may include data that would otherwise be accessed by the device responsive to launch of an application associated with the graphical object.

The graphical object itself may include a hyperlink that may be selectable to present the data at the device. Additionally or alternatively, the graphical object may include an icon associated with a particular file that includes the data, where the icon may be selectable to present the file at the device. Still further, the graphical object may include a button that is selectable to present the data at the device. Even further, the graphical object may include an icon associated with a particular application stored at the device, and in these implementations the icon may be selectable to launch the particular application and to present the data.

In another aspect, a method includes detecting a hover of a body part of a user above a touch-enabled display of a device, with the hover not including the body part physically touching the touch-enabled display. The method also includes identifying a graphical object proximate to the hover and loading data associated with the graphical object into random-access memory (RAM) of the device prior to the graphical object being selected based on the body part physically touching the touch-enabled display. The data as loaded into the RAM is not presented at the device from the RAM until touch input is received at the touch-enabled display to select the graphical object.

Proximate to the hover may include underneath the hover.

Additionally, in some examples the method may include receiving touch input at the touch-enabled display to select the graphical object and presenting at the device the data loaded into the RAM responsive to receiving the touch input at the touch-enabled display to select the graphical object.

In still another aspect, at least one computer readable storage medium (CRSM) that is not a transitory signal includes instructions executable by at least one processor to detect a hover of a physical object above a touch-enabled display accessible to the at least one processor. The hover does not include the physical object physically touching the touch-enabled display. The instructions are also executable to identify a graphical object within a threshold distance of the hover and to load data associated with the graphical object into random-access memory (RAM) accessible to the at least one processor prior to the graphical object being selected based on the physical object physically touching the touch-enabled display.

In some implementations, the graphical object may be a first graphical object and the data may be first data. In these implementations, the instructions may then be executable by the at least one processor to detect a change in the hover from a first location to a second location, where the second location may be proximate to a second graphical object that is different from the first graphical object. The instructions may then be executable to remove the first data from the RAM and to load second data into the RAM that is associated with the second graphical object based on the change in the hover from the first location to the second location. The second data may be different from the first data.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIGS. 3 and 5 show example GUIs with example graphical objects over which a user's finger may hover consistent with present principles;

FIG. 4 shows an example side cross-sectional view of a display of a device as it presents one or more example graphical objects consistent with present principles;

FIG. 6 shows a flow chart of an example algorithm consistent with present principles; and

FIG. 7 shows an example GUI 700 that may be used to configure one or more settings of a device undertaking present principles.

### DETAILED DESCRIPTION

The present application discloses systems and methods to make use of touchscreen sensitivity to cache certain data/content when a hover of a finger or other body part is detected above the display. The device might have certain zones (e.g., where certain buttons are presented) where the user might hover his or her finger when he or she is about to interact with the device, such as to select a given button using touch-based input for web browsing, page navigation, cloud computing functions, to enter a next page of a screen that's being presented, and/or to visit a certain file. Then the device may make use of the time between the hover detection and when user actually touches the display location at which the button is presented to pre-fetch the related data (whether that be a next page, a web page, or a file) that is predicted to be used next by the user, thereby saving loading time and reducing device latency. Present principles may also be used to improve cloud computing-based user experiences.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

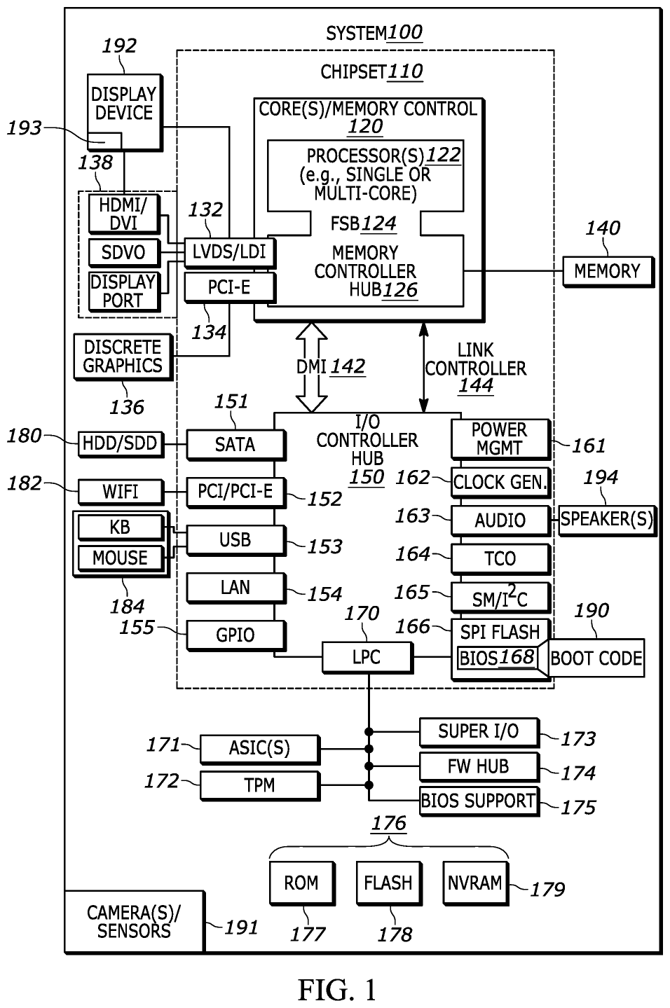

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). For example, the display device 192 may be a touch-enabled display that includes one or more mutual capacitance sensors and/or one or more self-capacitance sensors 193 for sensing both touch input to the touch-enabled display as well as hovers over the touch-enabled display. A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include one or more cameras 191 or other sensors (e.g., an infrared proximity sensor). The camera(s) 191 may gather one or more images and provide them to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather pictures/images and/or video.

Additionally, though not shown for simplicity, in some embodiments the system 100 may include a gyroscope that senses and/or measures the orientation of the system 100 and provides input related thereto to the processor 122, as well as an accelerometer that senses acceleration and/or movement of the system 100 and provides input related thereto to the processor 122. Still further, the system 100 may include an audio receiver/microphone that provides input from the microphone to the processor 122 based on audio that is detected, such as via a user providing audible input to the microphone. Also, the system 100 may include a GPS transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

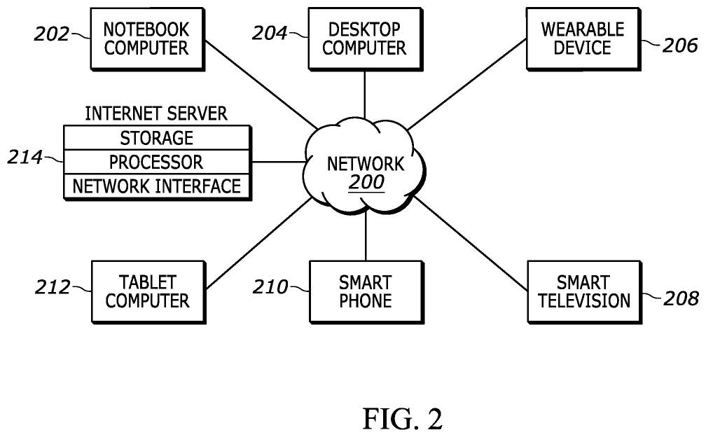

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

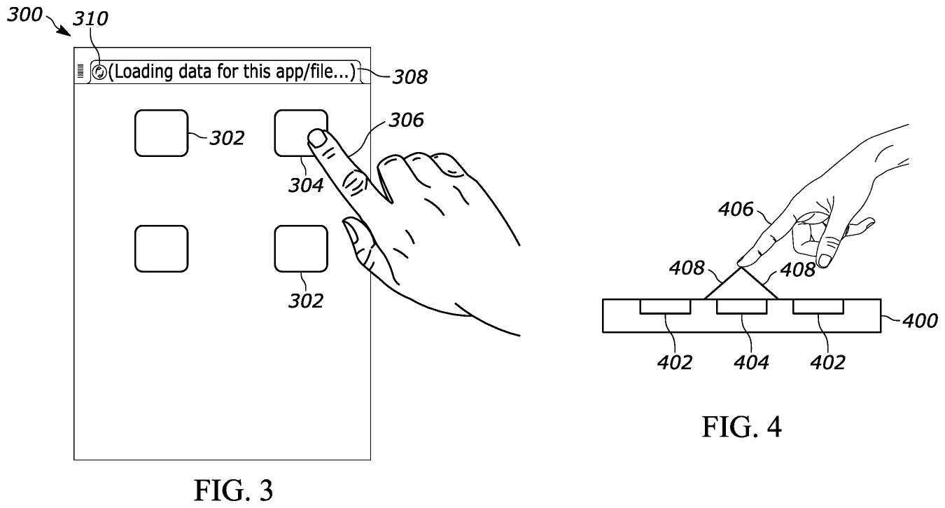

Now referring to FIG. 3, it shows an example consistent with present principles. Specifically, FIG. 3 shows a graphical user interface (GUI) 300 that may be presented on the touch-enabled display of a device such as a mobile telephone, smart watch, tablet computer, etc. The GUI 300 may include plural graphical objects 302, which may be icons or tiles in this case that are associated with respective applications that may be launched responsive to selection of a respective graphical object 302. Additionally or alternatively, one or more of the graphical objects 302 may be associated with respective files that may be presented responsive to selection of a respective graphical object 302. The file may be, for instance, a word processing document, a portable document format (PDF) document, an image file, etc. Also, note that the GUI 300 itself may be presented as part of a home screen or applications/files list for the device.

As also shown in FIG. 3, a first graphical object 304 of the graphical objects 302 is being interacted with by a user using his or her index finger 306. The interaction is established by the user hovering the index finger 306 above or at least within a threshold distance of a display location at which at least a portion of the object 304 is presented, without the user actually physically touching the display with the finger 306 or any other body part for that matter.

Consistent with present principles, responsive to the device detecting the hover of the finger 306, the device may begin caching or preloading data associated with the object 304 into random-access memory (RAM) of the device. This may be done so that the data may be presented relatively faster when the user actually touches or otherwise selects at least a portion of the object 304 than when not cached prior to receipt of the touch input.

In implementations where the graphical object 304 is an icon that is selectable using touch input to the touch-enabled display to launch a particular software application (e.g., a weather application, a news application, etc.), the data itself that is cached into the RAM may be or include data that would otherwise be accessed and presented by the device upon launch of the associated application itself. In implementations where the graphical object 304 is an icon that is selectable using touch input to the touch-enabled display to present a particular file such as a word processing document, the data that is cached into the RAM may be or include the file itself that would otherwise be accessed and presented by the device upon selection of the object 304 using touch input directed to the object 304 (or even using any/all other input types other than hovering that might be used to select the object 304, such as left-click cursor input).

Still in reference to FIG. 3, in some examples responsive to detecting the hover the device may present a text indication 308 that data associated with the object 304 is being loaded into RAM. Additionally or alternatively, responsive to detecting the hover the device may present an icon or other non-text indication 310 that data associated with the object 304 is being loaded into RAM, such as an animated arrangement of arrows that travel in a circular fashion about a center as shown.

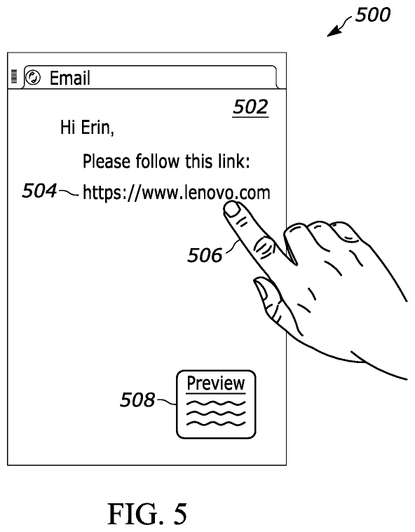

FIG. 4 shows a side cross-sectional view of a touch-enabled display 400 of a device. In this example, the display 400 is presenting one or more graphical objects 402, including a graphical object 404 over which a user's finger 406 is hovering. In order for the device to cache data associated with the object 404 consistent with present principles, the hover of the finger 406 may be placed directly above at least a portion of the object 404 as presented on the display 402 and, in some examples, within a threshold height of the portion of the object 404.

Additionally or alternatively, the hover may be placed proximate to but possibly not actually directly over any portion of the object 404 so long as at least a portion of the finger 406 is at least within a threshold distance of the object 404 in all three dimensions. The threshold distance is illustrated by each of the lines 408 of equal length shown in FIG. 4, which together demonstrate the hover range from the finger to the outer surface of the display 400 that is established by the threshold distance to invoke the caching of data.

The hover's height and X-Y location relative to the plane of the outer surface of the display 400 may be detected using one or more capacitive sensors in the touch-enabled display 400, such as mutual capacitance sensors, self-capacitance sensors, and/or a combination of the two. The hover height and X-Y location over the display may be determined based on the respective amounts of the hover's disturbance of the display's electrical field at various display locations.

Specifically, different amounts of disturbance may be detected by different respective capacitive sensors located at different locations on the display 400, and a greatest amount of disturbance detected by any one of the sensors may then be selected. This relatively greatest amount of disturbance may then be correlated to a hover height at the location of the respective sensor using a relational database that correlates respective greater hover heights with respective lesser disturbances. This correlation may in turn be used to determine whether the actual hover height is within a threshold height of a given graphical object consistent with present principles, where the threshold height may be a non-zero number that is less than the maximum height at which the capacitive sensor can sense a disturbance.

Additionally, the location of the sensor that sensed the relatively greatest amount of disturbance may be directly correlated to an X-Y location of the hover itself. A graphical object with at least a portion thereof being presented at that X-Y location may then be determined as the graphical object over which the user is hovering.

In addition to or in lieu of the foregoing, the hover may be detected using input from a camera on or in communication with the device, such as the camera 191 disclosed above. The camera may be disposed on a portion of the device adjacent to the display 400 on a same side of the device as the display 400, or may be located elsewhere within the user's environment assuming it is still oriented to provide images showing the finger 406 with respect to the display 400. The device may then execute a spatial analysis algorithm to determine the location of the finger 406 with respect to the display 400 in all three dimensions. Additionally or alternatively, the device may compare the size of the finger 406 as shown in the image(s) from the camera to the size of other known objects as shown in the image(s) to deduce the location of the finger 406 given the known locations and sizes of the other objects.

Still further, the location of the finger hover may be detected using an infrared (IR) proximity sensor on the device. The IR proximity sensor may include one or more IR light-emitting diodes (LEDs) for emitting IR light as well as one or more photodiodes and/or IR-sensitive cameras for detecting reflections of IR light from the LEDs off of the user's body/finger back to the IR proximity sensor. The time of flight and/or detected intensity of the IR light reflections may then be used to determine the height of the most-proximate portion of the user's finger 406 to the touch-enabled display 400 using a relational database that correlates respective times of flight and/or intensities with respective hover heights. Note that radar transceivers and/or sonar/ultrasound transceivers and associated algorithms may also be used for determining hover height.

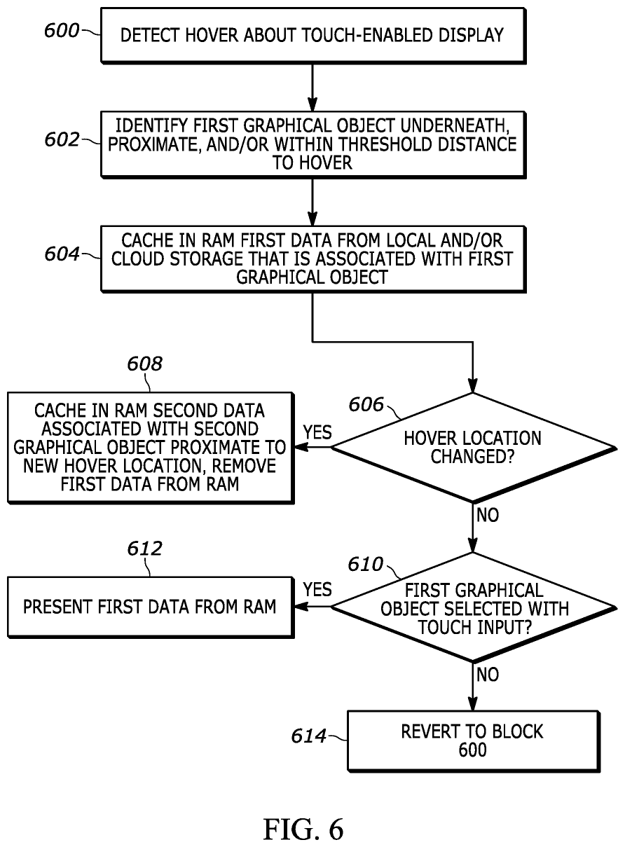

Continuing the detailed description in reference to FIG. 5, it shows an example GUI 500 for an email application as presented on the touch-enabled display of a device consistent with present principles. The GUI 500 is shown as presenting a particular email 502 that has been received at the device. Among other things, the email may include a hyperlink 504 that may be selectable by the user physically touching any location of the display presenting a portion of the hyperlink to then cause a web page associated with and/or indicated by the hyperlink to be presented.

However, before physically touching any such location, the user might hover at least a portion of an index finger 506 over at least a portion of the hyperlink 504. Responsive to detecting this non-touch hover over the hyperlink 504, the device may begin caching data associated with the hyperlink 504. For example, the device may issue an HTTP get request to then download the web page itself and store it in RAM of the device until the user actually touches a portion of the display presenting the hyperlink 504. Then when the user actually touches the portion presenting the hyperlink, the GUI 500 may be removed and the downloaded web page as stored in the RAM may be presented.

FIG. 5 also shows that in some examples, responsive to the device detecting the hover and beginning to cache the associated data, a preview thumbnail image 508 may be presented of the web page as currently cached. The image 508 may be presented smaller than the actual web page itself would be upon touch input to select the hyperlink 504. Additionally, the image 508 may animate and change over time so that as more portions of the web page are downloaded and cached at the device responsive to the hover, those portions of the web page are presented as part of the image 508.

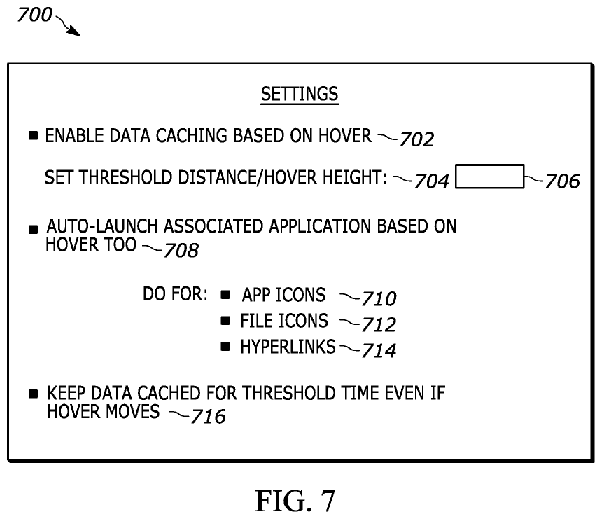

Now in reference to FIG. 6, it shows example logic that may be executed by a device such as the system 100 in accordance with present principles. Beginning at block 600, the device may detect a hover of a portion of a body part of a user above its touch-enabled display as described herein. The logic may then proceed to block 602 where the device may identify a first graphical object for which at least a portion thereof is located underneath the hover, proximate to the hover, and/or within a threshold distance of the hover. The logic may then proceed to block 604 where the device may cache/load first data into the device's RAM that is associated with the first graphical object. The first data itself may be accessed for caching from local storage on the device, from cloud storage accessed over the Internet, from a website or server accessed over the Internet, etc.

From block 604 the logic may then proceed to decision diamond 606. At diamond 606 the device may determine whether the location of the hover has changed with respect to the location of the display. An affirmative determination at diamond 606 may cause the logic to proceed to block 608. At block 608 the device may determine a second graphical object underneath, proximate, and/or within a threshold distance to the new location of the hover and then cache/load second data into the device's RAM that is associated with the second graphical object. Additionally, in some examples the device may remove or delete the first data from the RAM responsive to loading the second data into the RAM. However, in other implementations the device may either keep the first data loaded into the RAM indefinitely or may wait a threshold non-zero amount of time (e.g., thirty seconds) before removing the first data from the RAM based on loading the second data into the RAM.

Referring back to decision diamond 606, note that if a negative determination is made instead of an affirmative one, the logic may instead proceed to decision diamond 610. At diamond 610 the device may determine whether the first graphical object has actually been selected with touch input by the user physically contacting a portion of the display that presents at least a portion of the first graphical object. A negative determination at diamond 610 may cause the logic to proceed to block 614 where the logic may revert back to block 600 and proceed therefrom. However, in other implementations a negative determination at diamond 610 may instead cause the logic to revert back to another step in the process, such as reverting back to decision diamond 606.

If an affirmative determination were made at diamond 610 rather than a negative one, the logic may instead proceed to block 612. At block 612, the device may present the first data as loaded into the RAM at the device responsive to the touch input to select the first graphical object, whether that data is visual data or audio data or both. For example, the cached first data may include an audio video file and thus the device may begin playback of the audio video file at block 612.

Before moving on in the detailed description, it is to be further understood that present principles also apply to the hover height of physical objects other a body part of a user. For example, the hover the tip of a stylus or pen may also be detected and used for caching data associated with a given graphical object consistent with present principles.

Also before moving on in the detailed description, it is to be understood that data may be cached based on the device detecting a non-touch hover over its display not just before the graphical object is actually touched based on a physical object making physical contact with the display, but also possibly before the graphical object is selected by any other methods besides non-touch hover input such as based on voice command, left-click cursor/mouse input, etc.

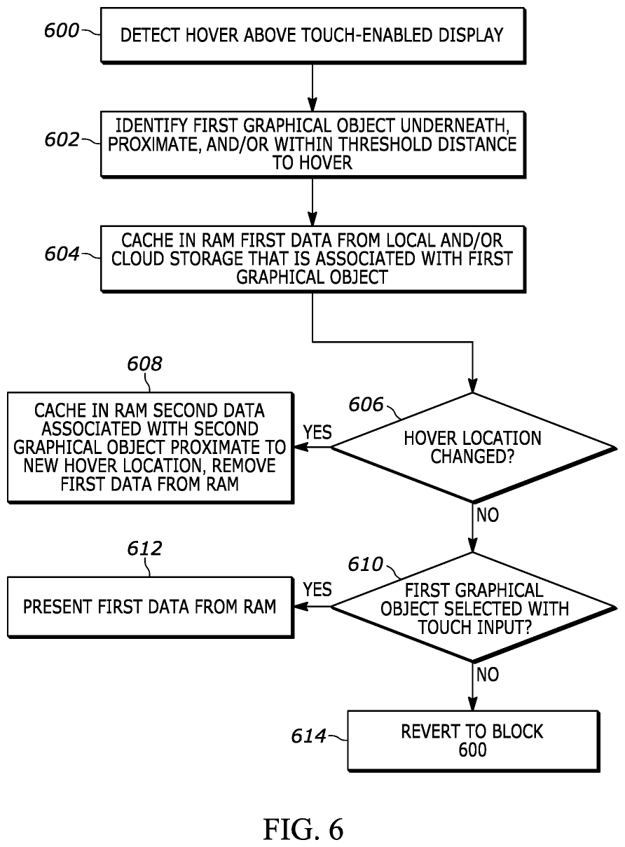

Continuing now in reference to FIG. 7, it shows a GUI 700 that may be presented on a display of a device to configure one or more settings of the device to operate consistent with present principles. Each of the options/settings that will be described below may be selected by selecting the check box shown adjacent to the respective option through touch input, cursor input, etc.

As shown, the GUI 700 may include a first option 702 that may be selectable to enable the device to undertake present principles. For example, the option 702 may be selected to enable a setting for the device to undertake the functions described above in reference to FIGS. 3-5 as well as to execute the logic of FIG. 6.

The GUI 700 may also include a setting 704 for a user to set a threshold distance and/or threshold height of a hover that may be used by the device consistent with present principles to cache certain data in the device's RAM that is associated with a graphical object when a user's finger or other physical object is within the threshold distance or height to the graphical object. The threshold distance or height may be set by directing text/numerical input to box 706 to establish the threshold distance or height in, e.g., millimeters, centimeters, inches, etc. The numerical input itself may be provided after selecting the box 706 using a soft keyboard presented on the device's display, using voice input, etc.

As also shown in FIG. 7, the GUI 700 may include an option 708 that may be selectable to set the device to, responsive to detection of a non-touch hover over its display, launch an application associated with a graphical object underneath or proximate to the hover and to load the application itself into RAM (in addition to caching data associated with that graphical object).

Still further, in some examples the GUI 700 may include options 710, 712, 714 for particular respective classes of graphical objects for which associated data should be cached. The options 710, 712, 714 may be presented so that a user might select certain classes but not all classes of graphical objects for caching of associated data. Example classes include application icons (option 710), file icons (option 712), and hyperlinks (option 714). Other classes may also be listed such as GUI buttons of various types, though not shown for simplicity.

Even further, in some implementations the GUI 700 may include an option 716. The option 716 may be selectable to set the device to keep data associated with a hovered-over graphical object cached in the device's RAM for at least a threshold non-zero amount of time even if the user removes his or her finger altogether from proximity to the display or even if the user moves to hovering over a different display location. The threshold non-zero amount of time may be sufficiently long (e.g., thirty seconds) so that the data remains cached even if the user changes his or her mind and returns to the graphical object for which the data has been cached to then select the graphical object itself using touch input. In some examples, the GUI 700 may even include an input box similar to the box 706 at which the threshold amount of time may be set by the user, though this input box is not shown in FIG. 7 for simplicity.

It may now be appreciated that present principles provide for an improved computer-based user interface that improves the functionality, response time, and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. A device, comprising:
at least one processor;
a touch-enabled display accessible to the at least one processor; and
storage accessible to the at least one processor and comprising instructions executable by the at least one processor to:
detect a hover of a body part of a user above the touch-enabled display, the hover not comprising the body part physically touching the touch-enabled display;
identify a graphical object underneath the hover;
prior to the graphical object being selected based on the body part physically touching the touch-enabled display, cache data associated with the graphical object; and
responsive to detection of the hover and prior to the graphical object being selected based on the body part physically touching the touch-enabled display, present an indication on the touch-enabled display, the indication specifying through text that the data associated with the graphical object is being cached, the text not establishing the data itself.

2. The device of claim 1, comprising random-access memory (RAM) accessible to the at least one processor, wherein caching the data comprises loading the data into the RAM.

3-15. (canceled)

16. A method, comprising:
detecting a hover of a body part of a user above a touch-enabled display of a device, the hover not comprising the body part physically touching the touch-enabled display;
identifying a graphical object proximate to the hover;
prior to the graphical object being selected based on the body part physically touching the touch-enabled display, loading data associated with the graphical object into random-access memory (RAM) of the device, the data as loaded into the RAM not being presented at the device from the RAM until touch input is received at the touch-enabled display to select the graphical object; and
responsive to detecting the hover of the body part and prior to the graphical object being selected based on the body part physically touching the touch-enabled display, presenting an indication on the touch-enabled display, the indication specifying through text that the data associated with the graphical object is being loaded, the text not establishing the data itself.

17-18. (canceled)

19. At least one computer readable storage medium (CRSM) that is not a transitory signal, the computer readable storage medium comprising instructions executable by at least one processor to:
present a settings graphical user interface (GUI) on a touch-enabled display accessible to a device, the settings GUI comprising a option that is selectable a single time to set the device to subsequently perform plural future processes of detecting a respective hover above the touch-enabled display, identifying a respective graphical object within a threshold distance of the respective hover, and loading respective data associated with the respective graphical object into random-access memory (RAM) of the device prior to the respective graphical object being selected based on a physical touching of the touch-enabled display;
detect a first hover above the touch-enabled display, the first hover not comprising a physical object physically touching the touch-enabled display;
identify a first graphical object within the threshold distance of the first hover; and
based on the option being selected from the settings GUI and prior to the first graphical object being selected based on the physical object physically touching the touch-enabled display, load first data associated with the first graphical object into the RAM.

20-25. (canceled)

26. The method of claim 16, comprising:
responsive to detecting the hover of the body part and prior to the graphical object being selected based on the body part physically touching the touch-enabled display, presenting a preview of the data on the touch-enabled display, the preview and the data both comprising a web page, wherein the preview changes over time while the body part hovers above the touch-enabled display so that additional portions of the web page that are loaded during the hover are presented as part of the preview after being loaded.

27-28. (canceled)

29. The device of claim 1, wherein the instructions are executable to:
present a settings graphical user interface (GUI) on the touch-enabled display, the settings GUI comprising a first option that is selectable a single time to set the device to subsequently perform plural processes of detecting a respective hover over the touch-enabled display, identifying a respective graphical object underneath a respective hover, and presenting a respective indication that data associated with a respective graphical object over which a hover is detected is being cached.

30. The device of claim 29, wherein the settings GUI further comprises a second option different from the first option, the second option being selectable to set the device to subsequently, for the performance of the processes, launch a respective application associated with a respective graphical object over which a respective hover is detected.

31. The device of claim 29, wherein the settings GUI further comprises a setting at which a threshold distance it settable, the threshold distance establishing a distance from the touch-enabled display within which a body part is to be determined as hovering above a respective graphical object.

32. The device of claim 31, wherein the settings GUI comprises an input box at which input specifying the threshold distance is providable.

33. The device of claim 31, wherein a body part hovering within the threshold distance is sensed by the device using one or more sensors in the touch-enabled display, and wherein the threshold distance is less than a maximum distance at which the one or more sensors can sense a body part.

34. The device of claim 1, wherein the instructions are executable to:
detect the hover of the body part of a user above the touch-enabled display using input from a camera.

35. The device of claim 1, wherein the instructions are executable to:
detect the hover of the body part of a user above the touch-enabled display using input from an infrared (IR) proximity sensor.

36. The device of claim 1, wherein the instructions are executable to:
detect the hover of the body part of a user above the touch-enabled display using input from a radar.

37. The device of claim 1, wherein the instructions are executable to:
detect the hover of the body part of a user above the touch-enabled display using input from a sonar transceiver and/or ultrasound transceiver.

38. The method of claim 16, comprising:
presenting a graphical user interface (GUI) on the touch-enabled display, the GUI comprising a first option that is selectable a single time to set the device to subsequently perform plural processes of detecting a respective hover over the touch-enabled display, identifying a respective graphical object proximate to a respective hover, and presenting a respective indication that data associated with a respective graphical object proximate to a respective a hover is being loaded.

39. The method of claim 38, wherein the GUI comprises at least second and third options different from the first option, the second and third options each being respectively selectable to select a different class of graphical objects for which associated data should be cached upon detecting a respective hover.

40. The method of claim 39, wherein the different classes comprise two or more of: application icons, file icons, hyperlinks.

41. The method of claim 38, wherein the GUI further comprises a second option different from the first option, the second option being selectable to set the device to subsequently, for the performance of the processes, launch a respective application associated with a respective graphical object proximate to a respective hover that is detected.

42. The method of claim 38, wherein the GUI further comprises a setting at which a threshold distance it settable, the threshold distance establishing a distance from a respective graphical object within which a body part is to be determined as proximate to the graphical object.

43. The method of claim 16, comprising:
detecting the hover using one or more of: input from a camera, input from an infrared (IR) proximity sensor, input from a radar, input from a sonar transceiver, input from an ultrasound transceiver.
